(19) United States
(12) Patent Application Publication
(10) Pub. No.: US 2026/0188884 A1
(43) Pub. Date: Jul. 2, 2026

(54) WAVEGUIDE

(71) Applicant: Robert Bosch GmbH, Stuttgart (DE)

(72) Inventors: Daniel Lopez Cuenca, Stuttgart (DE); Istvan Ther, Budapest (HU); Johannes Meyer, Ettlingen (DE); Julio Alberto Gonzalez Marin, Stuttgart (DE)

(21) Appl. No.: 18/859,805

(22) PCT Filed: Jul. 3, 2023
(86) PCT No.: PCT/EP2023/068177

§ 371 Date: Oct. 24, 2024

(30) Foreign Application Priority Data
Sep. 30, 2022 (DE) 10 2022 210 415.3

(51) Int. Cl. H01P 3/12

(52) U.S. Cl. CPC H01P 3/12

(57) ABSTRACT

A waveguide including two waveguide parts. Each waveguide part has a waveguide body and a part of at least one waveguide channel, which are arranged such that they form the at least one waveguide channel when the two waveguide parts are joined together. The opposing surfaces of the two waveguide parts are configured in parallel. A pin is formed in the waveguide body of the first waveguide part, which projects in a direction of the second waveguide part. A recess receiving the pin is formed in the waveguide body of the second waveguide part. The pin and the recess are arranged coaxially relative to one another and the pin and the recess do not come into contact in the assembled state of the waveguide.

### FIELD

The present invention relates to a waveguide including two waveguide parts that are joined together. Each waveguide part has a part of at least one waveguide channel (i.e. a part of a waveguide channel or a part of multiple waveguide channels), in particular an upper or lower half of the at least one waveguide channel. The waveguide parts are, for example, welded, glued, screwed or similar. After the waveguide parts are joined together, they form the at least one waveguide channel. Opposing surfaces of the two waveguide parts are designed in parallel.

### BACKGROUND INFORMATION

Waveguides are produced, for example, by molding two waveguide parts and then joining them together. Each waveguide part has a waveguide body into which a part of at least one waveguide channel is incorporated by means of conventional methods, such as milling or injection molding. The two waveguide parts are then joined together at their waveguide bodies, thus creating a fixed connection. When joined together, the parts of the at least one waveguide channel are aligned one above the other and combined to form at least one waveguide channel. The parts are joined together using methods such as screwing, gluing, press-fitting, welding or similar.

Leakage of electromagnetic waves carried in the waveguide can occur at the joint. This is caused by the interruption of current paths on the surface due to imperfect galvanic contacts. Montgomery et al., “Principles of Microwave Circuits,”Stevenage: IET, 1987, describes dividing the waveguide in a region where only small or ideally no currents flow. For example, this region is in the middle of the longer side in a rectangular waveguide for the fundamental mode. If the waveguide is divided in this region, the symmetry is largely preserved, and ideally no leakage occurs, even if there is an imperfect galvanic contact between the two waveguide parts, for example due to gluing or press-fitting.

However, this does not completely prevent leakage. Even if the design of the waveguide were perfectly symmetrical, which is usually not the case due to bends and components such as transistors, small imperfections and manufacturing tolerances will result in a slightly asymmetrical waveguide, resulting in at least a small amount of energy leaking between the waveguide parts. However, small asymmetries also result in smaller leakages, so if the asymmetry is small enough, depending on the application, the leakage is negligible.

Typically, an interstice remains between the waveguide bodies. The aligned surfaces of the waveguide bodies run parallel to one another, so they can be regarded as plates of a plate capacitor. Even the smallest leakages can generate an excitation of a parallel plate mode between the parallel surfaces of the waveguide bodies of the waveguide parts. As long as the amount of energy is small enough, the leakage is negligible. However, the excitation can cause resonance within the interstice between the two waveguide bodies of the waveguide parts or between adjacent waveguide channels. As a result of resonance, the amount of energy of the parallel plate mode can be drastically increased, which results in a reduction in the mode propagating in the waveguide. As a result, leakage is increased, and the performance of the waveguide (or a waveguide antenna using the waveguide) is reduced. The occurrence of resonances depends on the frequency used and geometric boundary conditions of the waveguide and the interstice between the waveguide parts. This may result in waveguide designs not being usable or requiring welding for joining.

### SUMMARY

According to an example embodiment of the present invention, a waveguide has a pin formed in the waveguide body of a first waveguide part. The pin projects from the first waveguide part in the direction of the second waveguide part, preferably perpendicularly to the surface of the first waveguide part. The pin may have various shapes, e.g., cylindrical or columnar as a bolt, conical as a cone, truncated cone, pyramid or truncated pyramid and have a circular, elliptical, square, rectangular, trapezoidal or other polygonal cross section. A recess is provided in the second waveguide part, which receives the pin and is preferably formed in the second waveguide part perpendicularly to the surface of the second waveguide part. The recess is adapted to the pin and is preferably the shape of the counterpart to the pin, but can also have any other shape. The pin and the recess are arranged coaxially relative to one another. In addition, the pin and the recess are shaped such that the pin can penetrate the recess without touching its walls when the waveguide parts are joined together. A gap therefore remains between the pin and the recess, and no galvanic contact is created.

The pin, the recess, and the gap between them can be interpreted as a short coaxial line when joined together. The pin serves as the inner conductor, the waveguide body around the recess serves as the outer conductor, and the air-filled gap between them serves as the dielectric medium. As a result, the geometric boundary conditions of the parallel plate mode between the parallel surfaces of the waveguide bodies are changed. The pin and the recess act as a coaxial choke. By the positioning and number of pins and recesses, the resonance frequencies of the waveguide bodies can be controlled and removed in the relevant frequency band. As a result, the leakage of energy from the waveguide is reduced.

According to an example embodiment of the present invention, advantageously, the length of the pin corresponds to a quarter of the wavelength (λ₀/4) of a signal for which the at least one waveguide channel is designed. As a result, the coaxial choke consisting of pin and recess acts as a short circuit on the first waveguide part, which significantly reduces the propagation of the parallel plate mode.

The coaxial choke has a particularly advantageous effect in the configurations of the waveguide channels described below, but can be applied to any configuration.

In one example embodiment of the present invention, the waveguide has a bent or kinked waveguide channel which surrounds a region in which a resonant cavity can form in the interstice between the two waveguide parts. Resonance forms when one dimension of the resonant cavity corresponds approximately to half the free-space wavelength (or a multiple thereof) of the signal propagating through the waveguide channel (l≈λ₀/2). The pin is preferably arranged in this region, surrounded by the bent or kinked waveguide channel, of the waveguide body of the first waveguide part. Accordingly, the recess is also arranged in the region, surrounded by the bent or kinked waveguide channel, of the waveguide body of the second waveguide part. As a result, the resonant cavity is destroyed, and the parallel plate mode in the interstice between the waveguide bodies is significantly reduced. In general, any shape of the waveguide which surrounds such a region in which a resonant cavity can form can be relevant. The following shapes are particularly relevant: a U-shaped waveguide channel, in which the waveguide channel runs in parallel at the two legs, a V-shaped waveguide channel or an L-shaped waveguide channel, in which the legs are angled relative to one another.

According to an example embodiment of the present invention, it is also possible for multiple pins to be formed in the waveguide body of the first waveguide part and for multiple recesses corresponding to the pins to be formed in the waveguide body of the second waveguide part. This allows the parallel plate modes to be suppressed selectively and particularly effectively. Likewise, one or more pins and one or more recesses can also be formed in the waveguide body of the first waveguide part, and correspondingly one or more recesses and one or more pins can be formed in the second waveguide part.

In particular, the multiple pins and the multiple recesses are arranged along a straight line. The coaxial chokes then form a “fence” that effectively suppresses the parallel plate mode over a region. If the straight line along which the multiple pins and the multiple recesses are arranged runs parallel to a waveguide channel, the parallel plate mode formed perpendicularly to the parallel plate mode is suppressed over the length of the waveguide channel.

In a further example embodiment of the present invention, the waveguide has two parallel waveguide channels. In the region of the waveguide body between the two parallel waveguide channels, a resonant cavity can form in the interstice between the two waveguide parts. In addition, unwanted energy coupling can occur between the two waveguide channels. Resonance forms when the spacing between the two parallel waveguide channels is approximately half the free-space wavelength (or a multiple thereof) of the signal propagating through the waveguide channel (l≈λ₀/2). The above-described arrangement of the pins and recesses along a straight line so that they form a “fence” is particularly advantageous for this embodiment. The straight line runs parallel to the waveguide channels and is arranged between the waveguide channels. The “fence” of coaxial chokes is thus formed along and between the parallel waveguide channels. As a result, the resonant cavity is destroyed, and the parallel plate mode in the interstice between the waveguide bodies is significantly reduced. This also prevents energy coupling between the waveguide channels across the interstice.

To form an impenetrable boundary, the multiple pins have a spacing of at most half the wavelength (d≤λ₀/2) of a signal for which the waveguide channel is designed.

### BRIEF DESCRIPTION OF THE DRAWINGS

Exemplary embodiments of the present invention are illustrated in the figures and explained in more detail in the following description.

FIG. 1 is a sectional view of a waveguide which is joined together from two waveguide parts and has a waveguide channel.

FIG. 2 is a sectional view of a pin and a recess in the waveguide according to an example embodiment of the present invention.

FIG. 3 is a partially transparent isometric view of an exemplary embodiment of the waveguide according to the present invention with a first configuration of a waveguide channel.

FIG. 4 is a partially transparent isometric view of a further exemplary embodiment of the waveguide according to the present invention with a second configuration of a waveguide channel.

### DETAILED DESCRIPTION OF EXAMPLE EMBODIMENTS

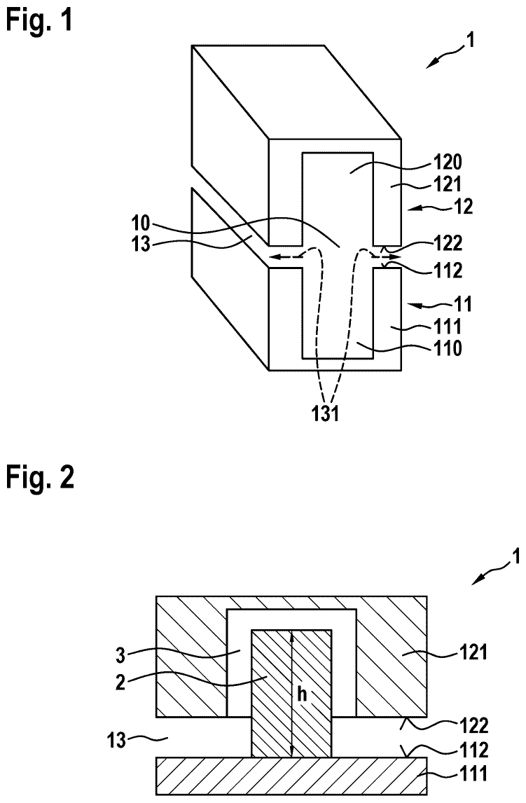

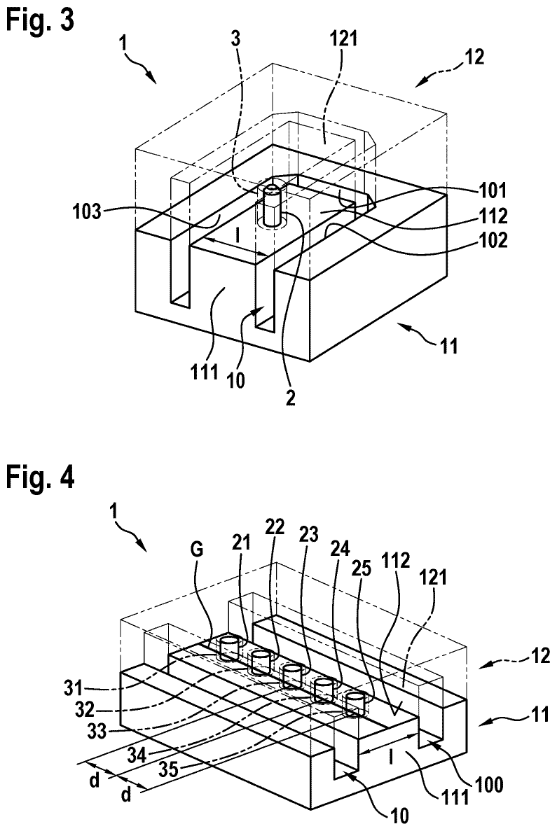

FIG. 1 shows a waveguide 1, which consists of two waveguide parts 11, 12. The first waveguide part 11 has a waveguide body 111 in which a cut-out 110 is formed, which in this example has a rectangular cross section and extends in the direction perpendicular to the cross section through the waveguide body 111. Likewise, the second waveguide part 12 has a waveguide body 121 in which a cut-out 120 is formed, which in this example has the same shape as the aforementioned cut-out 110 of the first waveguide part 11. Outside the cut-outs, the waveguide bodies 111, 121 have opposing surfaces 112 and 122 which run parallel to one another. To assemble the waveguide 1, the two waveguide parts 11, 12 are joined together at these surfaces 112 and 122. Joining methods that can be used include gluing or screwing in addition to welding. When joined together, the two cut-outs 110 and 120 together form a waveguide channel 10 designed as a rectangular hollow waveguide, in which electromagnetic signals (not shown here) can be guided. That is, the cut-outs 110, 120 are parts of the waveguide channel 10 that can easily be formed in the waveguide bodies 111, 121, for example by milling or injection molding, when separate from one another and form the waveguide channel 10 when joined together. By means of correspondingly designed cut-outs 110, 120, different shapes of waveguide channels and also multiple waveguide channels can be formed in the same waveguide 1. Reference is made in this respect to FIGS. 3 and 4. An interstice 13 can arise between the surfaces 112 and 122 when they are joined together, which interstice is shown as disproportionately large in the present drawings. Since the two surfaces 112 and 122 are parallel to one another, a parallel plate mode can form in the interstice 13. This leads to a leakage, represented by the arrows 131, of electromagnetic energy of the signals carried in the waveguide channel 10, as a result of which the energy of the signal in the waveguide channel 10 decreases.

In the other figures, identical components are identified by identical reference numerals, and reference is made to the above description for the explanation thereof.

FIG. 2 shows a detail of the waveguide 1 according to the present invention, which is constructed as shown in FIG. 1. The waveguide 1 according to the present invention has a pin 2, which extends perpendicularly from the surface 112 of the waveguide body 111 of the first waveguide part 11 in the direction of the second waveguide part 12, passing through the interstice 13. In the examples shown here, the pin 2 has a cylindrical shape. In addition, the pin 2 can have a cone at its tip (not shown in FIG. 2; see FIG. 3). In other embodiments not shown here, the pin 2 can also take other shapes, for example having a rectangular base or another round or polygonal base. Coaxially relative to this pin 2, a recess 3 is formed in the waveguide body 121 of the second waveguide 12, which recess projects into the waveguide body 121 perpendicularly to the surface 122 of the waveguide body 121 of the second waveguide part 12 (and, since this surface 122 is parallel to the surface 112 of the first waveguide part 11, also perpendicularly to the surface of the first waveguide part). In this example, the recess 3 also has a cylindrical shape, the diameter of which is larger than the diameter of the pin 2, and the depth of which is larger than the height h of the pin 2 (the spacing of the interstice 13 is typically negligible). Thus, after assembly, a gap remains between the pin 2 and the recess 3, and no galvanic contact is formed between the two. The pin 2 is oriented as centrally as possible in the recess 3. The recess 3 can also take other shapes, which can also differ from the shape of the pin 2, as long as there is a gap between the pin 2 and the recess 3. The height h of the pin 2 is one quarter of the wavelength (h=λ₀/4) of the signal in the waveguide channel 10, so that a short circuit is created at the base of the pin 2.

FIGS. 3 and 4 each show exemplary embodiments of the waveguide 1 according to the present invention with different configurations of the waveguide channel 10.

In FIG. 3, the waveguide channel 10 is U-shaped and has a base portion 101 and two leg portions 102, 103 running parallel to one another. The base portion 101 and the leg portions 102 and 103 surround a region of the waveguide body 111 on three sides. If the length l of this region of the waveguide body 111 between the leg portions 102, 103, i.e. the spacing between the leg portions 102, 103, is close to half the wavelength of the signal in the waveguide channel 10 (l≈λ₀/2), a resonant cavity can form in the interstice 13 between the parallel waveguide bodies 111 and 121 in the surrounding region, which resonant cavity amplifies the leakage of electromagnetic energy. In other exemplary embodiments (not shown), the waveguide channel can be V-shaped or L-shaped and can also surround a region in which a resonant cavity can form. According to the present invention, a pin 2 in the waveguide body 111 of the first waveguide part 11 and a recess 3 in the waveguide body 121 of the second waveguide part 12 are provided in the surrounding region, which are separated by a gap 4 (not shown here), as shown with reference to FIG. 2. The pin 2 and the recess 3 change the geometric boundary conditions so that the parallel plate mode is suppressed and no or only minimal leakage occurs.

FIG. 4 shows two waveguide channels 10 and 100 which run parallel to one another. The waveguide channels enclose a region of the waveguide body 111 from two opposing sides. If the length l of this region of the waveguide body 111 between the waveguide channels 10, 100, i.e., the spacing between the waveguide channels 10, 100, is close to half the wavelength of the signal in one of the waveguide channels 10, 100 (l≈λ₀/2), a resonant cavity can form in the interstice 13 between the parallel waveguide bodies 111 and 121 in the surrounding region, which resonant cavity amplifies the leakage of electromagnetic energy. According to the present invention, multiple pins (here five) 21 to 25 are provided in the waveguide body 111 of the first waveguide part 11, and correspondingly multiple recesses (here five) 31 to 35 are provided in the waveguide body 121 of the second waveguide part 12 in the surrounding regions, as shown with reference to FIG. 2. The multiple pins 21 to 25 are arranged along a straight line G, which runs parallel to the waveguide channels 10, 100 in the surrounding region. The multiple pins 21 to 25 are arranged at an equal spacing d from one another, which corresponds to half the wavelength of the signal in the waveguide channels 10, 100 (d=λ₀/2). Accordingly, the recesses 31 to 35 are also arranged along this straight line G and at an equal spacing d from one another. The pins 21 to 25 and the recesses 31 to 35 thus form a “fence” along the waveguide channels 10, 100, which suppresses the parallel plate mode, and thus no or only a small leakage occurs.

1-9. (canceled)

10. A waveguide, comprising:
two waveguide parts, each waveguide part of the two waveguard parts having a respective waveguide body, and a respective part of at least one waveguide channel which are arranged such that respect parts of the at least one waveguide channel, together, form the at least one waveguide channel when the two waveguide parts are joined together, opposing surfaces of the two waveguide parts being configured in parallel;
wherein a pin is formed in the respective waveguide body of a first waveguide part of the two waveguide parts, which pin projects in a direction of a second waveguide part of the two waveguide parts, and a recess receiving the pin is formed in the respective waveguide body of a second waveguide par of the two waveguide parts, the pin and the recess being arranged coaxially relative to one another and the pin and the recess not coming into contact with each other in an assembled state of the waveguide.

11. The waveguide according to claim 10, wherein the pin projects from the first waveguide body perpendicularly to a surface of the first waveguide body, and the recess formed in the second waveguide body extends perpendicularly to a surface of the second waveguide body.

12. The waveguide according to claim 10, wherein a length of the pin corresponds to a quarter of a wavelength of a signal for which the at least one waveguide channel is configured.

13. The waveguide according to claim 10, wherein the waveguide has a bent or kinked waveguide channel which surrounds a region, the pin being arranged in the region of the respective waveguide body of the first waveguide part that is surrounded by the bent or kinked waveguide channel.

14. The waveguide according to claim 10, wherein multiple pins are formed in the respective waveguide body of the first waveguide part and multiple recesses corresponding to the multiple pins are formed in the respective waveguide body of the second waveguide part.

15. The waveguide according to claim 14, wherein the multiple pins and the multiple recesses are arranged along a straight line.

16. The waveguide according to claim 15, wherein the straight line along which the multiple pins and the multiple recesses are arranged runs parallel to the waveguide channel.

17. The waveguide according to claim 14, wherein the waveguide has two parallel waveguide channels, the multiple pins and the multiple recesses being are arranged along a straight line which runs parallel to the waveguide channels between the waveguide channels.

18. The waveguide according to claim 14, wherein the multiple pins have a spacing of at most half a wavelength of a signal for which the waveguide channel is configured.
